(19) United States
(12) Patent Application Publication
(10) Pub. No.: US 2004/0169669 A1
(43) Pub. Date: Sep. 2, 2004

(54) Method and apparatus for display controling pixel sub-components

(76) Inventors: Bunpei Toji, Iizuka (JP); Tadanori Tezuka, Kaho-Gun (JP); Hiroki Taoka, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/770,563

(22) Filed: Feb. 4, 2004

(30) Foreign Application Priority Data
Feb. 4, 2003 (JP) 2003-026943

(51) Int. Cl. G09G 5/02

(52) U.S. Cl. 345/694

(57) ABSTRACT

An image data is filtered to output filtered image data, the filtered image data is stored to a frame memory, and each of a plurality of light emitting elements of a display device is controlled according to the filtered image data in the frame memory to make the display screen display the image data. When a first figure and a second figure are drawn adjacently, the first figure and the second figure are extended such that the first figure and the second figure have an overlap area. Thanks to the overlap area, a background image does not affect in the overlap area, thereby a front of discontinuity, which is not expected, does not appear.

### BACKGROUND OF THE INVENTION

1. Field of the Invention

The present invention relates to a display method for improving quality of display when a new image of one or more figures, which have a higher precision than a mere pixel precision, is blended using sub-pixel rendering technology over a background image, and arts related thereto.

2. Description of the Related Art

In some display devices, e.g. color liquid crystal panels, whose each pixel is composed of three light emitting elements, which emit red, green and blue and are aligned in a fixed order. Each of the three light emitting elements is smaller than one pixel, and corresponds to one pixel sub-component.

In the display devices, one line is composed of a plurality of pixels, which are aligned in a direction that the three light emitting elements are aligned. Furthermore, a display screen of each of the display devices is composed of a plurality of lines being aligned in a direction orthogonal to the direction.

A document 1 (title: “Sub-Pixel Font Renderings Technology”, web site: http://grc.com or subordinates thereof) and a document 2 (PCT international patent publication no. WO-00142762) disclose techniques performing suitable filtering processes, which utilize characteristic that each pixel thereof is composed of the three light emitting elements, to improve clearness of display by comparison with display according to the mere pixel precision.

To be more specific, in these techniques, in order to control each of the plurality of pixel sub-components of the display screen, three-times scaled image data is prepared. The three-times scaled image data has three-times resolution in the direction the three light emitting elements being aligned, by comparison with the display of the mere pixel precision. Each of elements of the three-times scaled image data is assigned to one of the plurality of pixel sub-components, and a color of each pixel is determined.

However, since using the determined color of each pixel may cause color unevenness, the following filtering processes are performed to output filtered image data.

According to the document 1, brightness of each of the pixel sub-components is adjusted using coefficients. Using the coefficients, a brightness value of a target pixel sub-component centered is multiplied by a factor of 3/9, brightness values of two outer pixel sub-components adjacent to the target pixel sub-component are multiplied by a factor of 2/9, and brightness values of two pixel sub-components further adjacent to the two outer pixel sub-components are multiplied by a factor of 1/9.

Each of the filtered image data composed of the pixel sub-components as described above is assigned to each of the plurality of light emitting elements, thereby performing sub-pixel precision display.

Next, referring to FIG. 5 and FIG. 6, problems encountered when figures are drawn using the conventional technology will now be explained. In conclusion, as shown in FIG. 5, when, first, a uni-color FIG. 1 is drawn, secondly, a uni-color FIG. 2 having the same color as the FIG. 1 is drawn adjacent to the FIG. 1, a front of discontinuity appears in an adjoining portion of the FIG. 1 and the FIG. 2.

In FIG. 5 and FIG. 6, both the FIG. 1 and the FIG. 2 are triangles, however, even when at least one of the FIG. 1 and the FIG. 2 is another polygon, such as a quadrangle, the front of discontinuity similarly appears in the adjoining portion of the FIG. 1 and the FIG. 2.

Needless to say, a desirable display result is that of a case where there is no front of discontinuity between the FIG. 1 and the FIG. 2 and color thereon is continuous smoothly.

Referring to FIG. 6, this point is explained in detail. Extracting a line of the FIG. 1 in the direction that the three light emitting elements are aligned, an original image data as shown in FIG. 6(a) is obtained.

Stated quite simply, it is assumed that the original image data does not have any pattern and the original image data is in uni-color. However, also when the original image data has one or more patterns and/or the original image data is not in uni-color, there is the same problem as described below.

Performing sub-pixel rendering processes using filters thereof to the original image data of FIG. 6(a), a result as shown in FIG. 6(b) is obtained. That is, since a background image affects especially both sides of the FIG. 1, colors of both sides of the FIG. 1 are different from those of the original image data. The background image has been allocated on a frame memory and has been displayed on a display device before the processes.

In fact, the sub-pixel rendering processes reduce color unevenness to improve quality of display appearance, thanks to the effect of both sides of the FIG. 1. However, this effect makes the matter worse, when one figure adjoins another figure.

As shown in FIG. 6(c), when, first, performing the sub-pixel rendering processes to image data of one line extracted from the FIG. 2 adjacent to the FIG. 1 to output the result thereof, secondly, displaying the result, as surrounded by a mark of “O” in FIG. 6(d), in the adjoining portion of the FIG. 1 and the FIG. 2, a part that has different color from that of the original image data exists at a joining part of the FIG. 1 and the FIG. 2.

When the above processes have been repeated regarding all the lines of the FIG. 1 and the FIG. 2, a front of discontinuity appears, as shown in FIG. 5.

Using the conventional techniques, when a plurality of figures are drawn adjacently using sub-pixel rendering processes, a front of discontinuity, which is not expected, appears, and the front of discontinuity lowers quality of display appearance.

### OBJECTS AND SUMMARY OF THE INVENTION

An object of the present invention is to provide a display method that can suppress the appearance of the front of discontinuity caused by the filtering processes.

A first aspect of the present invention provides a display method, using a display device having a display screen, the display screen having a plurality of lines, each of the plurality of lines having a plurality of pixels in a fixed order, each of the plurality of pixels having a plurality of light emitting elements, each of the plurality of light emitting elements corresponding to one of a plurality of pixel sub-components, the display method comprising: filtering image data using a filter having taps to output filtered image data comprising the plurality of pixel sub-components; storing the filtered image data to a frame memory; and controlling each of the plurality of light emitting elements according to the filtered image data comprising the plurality of pixel sub-components in the frame memory to make the display screen display the image data, wherein, when a first figure and a second figure are drawn adjacently, figure extension in at least one of the first figure and the second figure is performed such that the first figure and the second figure have an overlap area.

With this structure, since a boundary portion of the first figure and the second figure is overwritten by the overlap area, components of the background image diminish in the boundary portion, and hence a front of discontinuity, which is not expected, does not appear.

A second aspect of the present invention provides a display method as defined in the first aspect of the present invention, wherein the figure extension is based on data of a figure to be extended, the figure being one of the first figure and the second figure.

With this structure, since, when the extended image data has been drawn, it is sufficient to merely refer to the extended image data, the processes can be realized more simply.

A third aspect of the present invention provides a display method as defined in the first aspect of the present invention, wherein the figure extension is based on data of an adjacent figure of a figure to be extended, the figure being one of the first figure and the second figure.

With this structure, since data of the overlap area of the first image data becomes the same as data of the overlap area of the second image data, the overlap area and the other area thereof continue smoothly, and a fine display result can be obtained.

A fourth aspect of the present invention provides a display method as defined in the first aspect of the present invention, wherein width of the overlap area is determined according to a number of the taps of the filter.

With this structure, since a part where the front of discontinuity appears depends on the number of the taps of the filter and the width is determined according to the number of the taps of the filter, the front of discontinuity can be reduced rationally. Herein, the number of the taps is a number of input elements of the filter.

A fifth aspect of the present invention provides a display method as defined in the fourth aspect of the present invention, wherein, when the number of the taps of the filter is a value of “5”, the width of the overlap area is width of two light emitting elements.

With this structure, the front of discontinuity, which is caused by the filter having five taps, does not appear, a fine display result can be obtained.

A sixth aspect of the present invention provides a display method as defined in the fifth aspect of the present invention, wherein the figure extension is performed for both sides of the first figure and both sides of the second figure, by width of one light emitting element in a direction that the plurality of light emitting elements are aligned.

With this structure, since a sum of the width of the overlap area is width of two light emitting elements, the front of discontinuity, which is caused by the filter having five taps, does not appear. Furthermore, in both sides of the first/second figures, another figure can be adjoined without a front of discontinuity.

A seventh aspect of the present invention provides a display method, using a display device having a display screen, the display screen having a plurality of lines, each of the plurality of lines having a plurality of pixels in a fixed order, each of the plurality of pixels having a plurality of light emitting elements, each of the plurality of light emitting elements corresponding to one of a plurality of pixel sub-components, the display method comprising: filtering image data using a filter having a tap number to output filtered image data comprising the plurality of pixel sub-components; storing the filtered image data to a frame memory; and controlling each of the plurality of light emitting elements according to the filtered image data comprising the plurality of pixel sub-components in the frame memory to make the display screen display the image data, wherein, when a first figure and a second figure are drawn adjacently, the filtering the image data using the filter having taps to output the filtered image data comprising the plurality of pixel sub-components, excludes a portion of an adjoining side of the first figure and the second figure from an object that the filter operates.

With this structure, the filtering processes reduce color unevenness, furthermore, the front of discontinuity, which is caused by the filtering processes, does not appear.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of a display device in an embodiment of the present invention;

FIG. 2 is a flow chart of the display device in the embodiment of the present invention;

FIG. 3(a) to FIG. 3(e) are explanatory drawings showing processes of the line image data in the embodiment of the present invention;

FIG. 4 is a figure illustrating a display result in the embodiment of the present invention;

FIG. 5 is a figure illustrating a display result in the conventional display; and

FIG. 6(a) to FIG. 6(e) are explanatory drawings showing processes of the line image data in the conventional art.

### DETAILED DESCRIPTION OF THE PREFERRED EMBODIMENTS

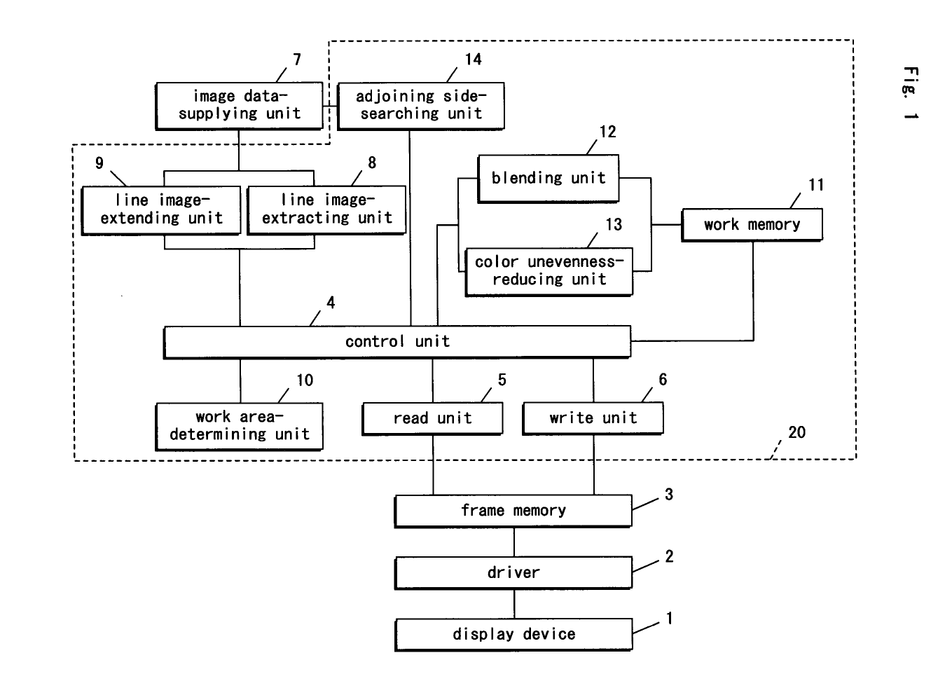

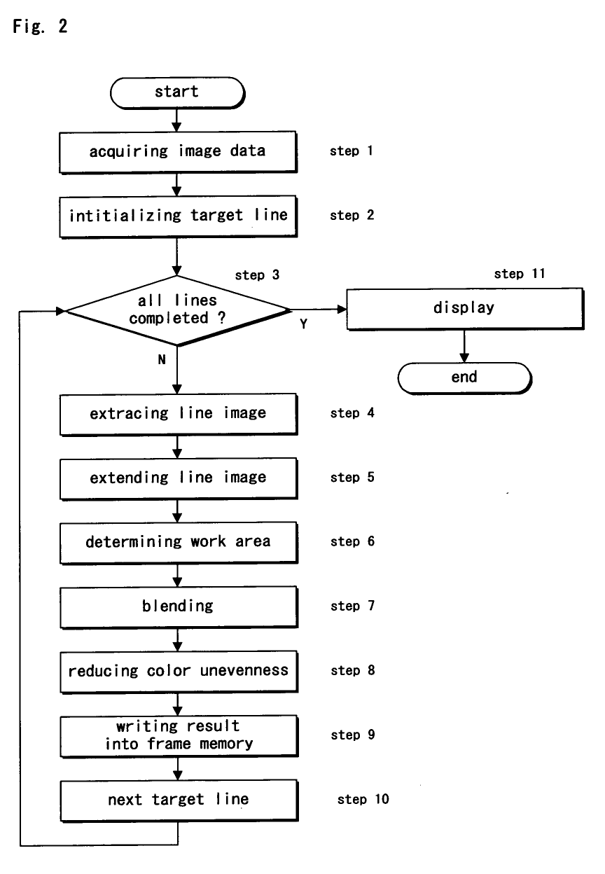

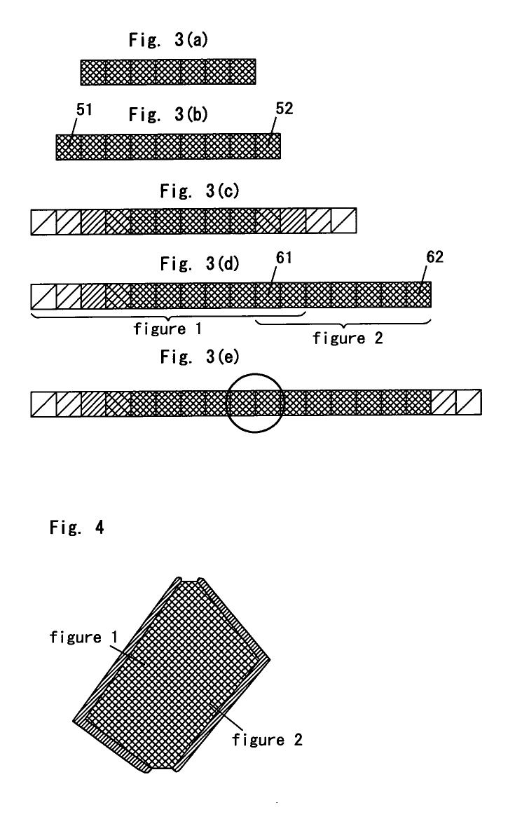

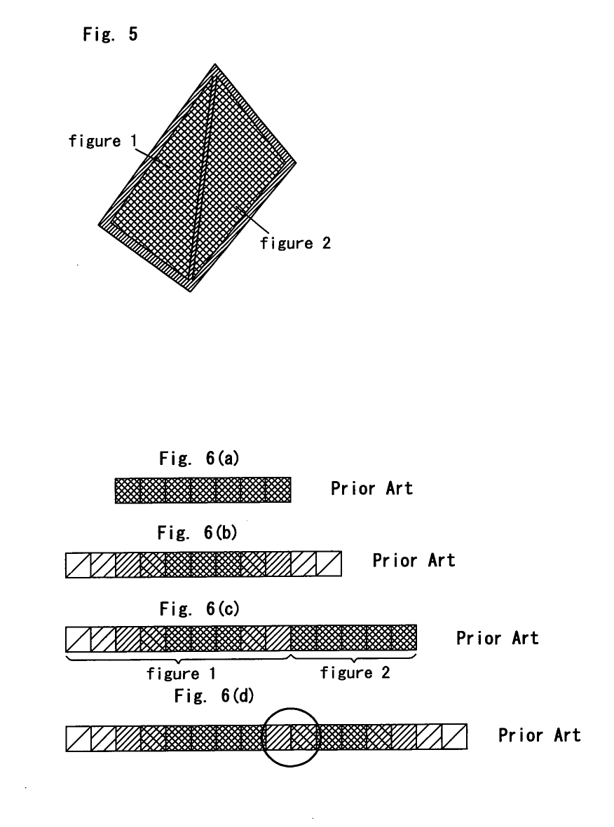

Next, referring to drawings, an embodiment of the present invention will now be explained. FIG. 1 is a block diagram of a display device in the embodiment of the present invention.

In FIG. 1, a display device 1 is a color liquid crystal panel. However, the display device 1 may be a plasma display or an organic electroluminescence display, and so on, instead of the color liquid crystal panel.

Each pixel of the display device 1 is composed of three light emitting elements, which emit red (R), green (G) and blue (B) respectively and are aligned in a direction in a fixed order, e.g. an order of RGB.

Each line of the display device 1 is composed of a plurality of pixels. And, a display screen of the display device 1 is composed of a plurality of lines being aligned in a direction orthogonal to the direction.

A driver 2 controls independently each of the plurality of light emitting elements of the display device 1.

A frame memory 3 supplies display data to the driver 2. Note that each of the plurality of light emitting elements of the display device 1 corresponds to each of a plurality of pixel sub-components stored on the frame memory 3, one by one.

In this specification, a “background image” means an image that has been stored in a frame memory 3 and has been displayed on the display screen of the display device 1. On the contrary, a “foreground image” means an image that is going to be stored in the frame memory 3. Once the foreground image has been stored completely in the frame memory 3 and the display screen of the display device 1 has been updated according to the frame memory 3, what had been the “foreground image” is no longer a “foreground image” but has become a “background image.”

Data of the foreground image is not image data itself supplied by an image data-supplying unit 7. Processes as described below are performed to the image data itself supplied by the image data-supplying unit 7 to generate the data of the foreground image, which is generally different from the image data itself supplied by the image data-supplying unit 7. In the following processes, the image data is handled by data of a line image in a direction that the three light emitting elements are aligned.

A control unit 4 executes a control program according to a flow chart of FIG. 2 to control each of elements of FIG. 1.

A read unit 5 reads data from a specific region, which is instructed by the control unit 4, of the frame memory 3. A write unit 6 stores data to a specific region, which is instructed by the control unit 4, of the frame memory 3.

The image data-supplying unit 7 supplies image data to a sub-pixel rendering unit 20 of this system. The image data may be bitmap image data or raster image data that is generated developing one or more vector images in a specific region of a memory.

A line image-extracting unit 8 extracts a line image instructed by the control unit 4 from the image data supplied by the image data-supplying unit 7. The line image is in the direction that the three light emitting elements are aligned.

In this example, the line image-extracting unit 8 extracts RGB values of pixel sub-components constituting a line image, the pixel sub-components being indicated using a starting point coordinate (x, y) of the line image and length “len” of the line image in the direction that the three light emitting elements are aligned.

A line image-extending unit 9 extends both ends of a line image extracted by the line-image extracting unit 8 outward in the direction that the three light emitting elements are aligned.

In this example, the line image-extending unit 9 updates the starting point coordinate (x, y) of the line image and the length “len” of the line image in the direction that the three light emitting elements are aligned, and sets RGB values of pixel sub-components existing in a portion extended by the line-image extending unit 9.

A work area-determining unit 10 determines a work area being composed of a lower portion, the line image data itself, and an upper portion. The lower portion is composed of M pixel sub-components that are added before the line image data in a direction where a coordinate of “x” becomes small, where a value of “M” is a natural number. The upper portion is composed of N pixel sub-components that are added after the line image data in a direction where the coordinate of “x” becomes large, where a value of “N” is a natural number.

In this example, a color unevenness-reducing unit 13 uses a filter with five taps. Therefore, for processes by the color unevenness-reducing unit 13, first, the work area-determining unit 10 determines each of the value of “M” and the value of “N” is a value of “2”. Secondly, the work area-determining unit 10 increases the value of “M” and the value of “N” such that both x-coordinate of a starting point of the work area and the length “len” are multiples of “3”.

A work memory 11 stores information required for processes of the control unit 4.

A blending unit 12 blends the line image data with data of a background image read from the frame memory 3 to output blended line image data.

The color unevenness-reducing unit 13 performs color unevenness-reducing processes to the blended image data outputted from the blending unit 12. The color unevenness-reducing processes are arbitrary, for example, it may be the processes written in the document 1.

In this example, the color unevenness-reducing processes are performed filtering only brightness components of the blended image, using the filter with five taps. However, other arbitrary processes may be performed.

An adjoining side-searching unit 14 searches an adjoining side of a first figure and a second figure among image data supplied by the image data-supplying unit 7.

As shown in FIG. 1, the sub-pixel rendering unit 20 according to the embodiment comprises: the control unit 4; the read unit 5; the write unit 6; the line image-extracting unit 8; the line image-extending unit 9; the work area-determining unit 10; the work memory 11; the blending unit 12; the color unevenness-reducing unit 13; and the adjoining side-searching unit 14.

When the adjoining side-searching unit 14 is used, the control unit 4 instructs the color unevenness-reducing unit 13 that a portion of the adjoining side searched by the adjoining side-searching unit 14 should not be filtered. When the adjoining side-searching unit 14 is used, generation of the overlap area described below in detail can be omitted. Even when the generation of the overlap area is omitted, a front of discontinuity does not appear.

Hereinafter, a case where the adjoining side-searching unit 14 is not used, that is, the sub-pixel rendering unit 20 does not include the adjoining side-searching unit 14, further where the overlap area is generated, is explained.

Next, referring to a flow chart of FIG. 2, each of processes will now be explained in detail. First, at step 1, the image data-supplying unit 7 supplies image data.

At step 2, the control unit 4 initializes a target line. At step 3, after checking that processes for all lines of the image data have not been completed, the control unit 4 instructs the line image-extracting unit 8 that line image data of the target line should be extracted. The line image-extracting unit 8 extracts, regarding the target line, RGB values of pixel sub-components constituting the target line image, the pixel sub-components being indicated using a starting point coordinate (x, y) of the line image and length “len” of the line image in the direction that the three light emitting elements are aligned.

At step 5, the control unit 4 instructs the line image-extending unit 9 that the line image extracted by the line image-extracting unit 8 should be extended.

The line image-extending unit 9 updates values as follows: The starting point coordinate (x, y) of the line image is changed to a coordinate (x-1, y); and the length “len” of the line image is changed to a value of “len+2”; and the line image-extending unit 9 copies RGB values of pixel sub-components of a neighboring portion, which is adjacent to an extended portion, to RGB values of pixel sub-components of the extended portion. The copied RGB values may be either RGB values of an extended figure or RGB values of a figure that adjoins the extended figure.

The line image-extending unit 9 returns this information to the control unit 4, and the control unit 4 stores this information into the work memory 11.

At step 6, the control unit 4 instructs the work area-determining unit 10 that a work area should be determined. The work area-determining unit 10 determines an x-coordinate of a starting point of the work area and length “len” of the work area, according to an x-coordinate of a starting point of the line image and length of the line image. The work area is determined such that the work area suits with the extended extracted line image, and further such that the work area includes an area for processes by the color unevenness-reducing unit 13.

Thanks to these processes, when the color unevenness-reducing unit 13 performs processes thereof, the filter operates equally on the line image and the neighboring portions of the line image. Thereby, color unevenness is reduced to improve quality of display appearance.

At step 7, the control unit 4 instructs the blending unit 12 to perform blending processes. The blending unit 12 requests the control unit 4 to read RGB values of a background image from the frame memory 3. Thereby, the blending unit 12 receives the RGB values of the background image, via a frame memory 3, the read unit 5, and the control unit 4. The blending unit 12 blends the line image data with the received background image to output blended line image data.

At step 8, the control unit 4 instructs the color unevenness-reducing unit 13 to perform color unevenness-reducing processes. The color unevenness-reducing unit 13 performs color unevenness-reducing processes, using the filter mentioned above, to output filtered line image data.

At step 9, the control unit 4 stores the filtered line image data into the frame memory 3 using the write unit 6. Thereby, processes of one target line are completed.

Next, at step 10, the control unit 4 updates the target line to a next target line, processes for all lines of the image data are repeated. Thereby, drawing one figure to the frame memory 3 is completed.

Next, the control unit 4 begins processes drawing a next figure to the frame memory 3.

When all figures have been drawn to the frame memory 3, the driver 2 controls independently each of the plurality of light emitting elements of the display device 1, according to the content of the frame memory 3. Thereby, at step 11, display of the display screen of the display device 1 is updated.

Next, referring to FIG. 3, a display result when a FIG. 1 and a FIG. 2 are drawn adjacently will now be explained. In conclusion, according to the embodiment, a front of discontinuity of FIG. 6, which concerns the conventional techniques, does not appear.

When a line image is extracted from the FIG. 1 in the direction that the three light emitting elements are aligned, original image data as shown in FIG. 3 (a) is obtained.

Stated quite simply, it is assumed that the original image data does not have any pattern and the original image data is in uni-color. However, also when the original image data has one or more patterns or the original image data is not in uni-color, there is the same problem.

Next, as shown in FIG. 3(b), an extended portion 51 is added to a left end of the original image and an extended portion 52 is added to a right end of the original image. The extended original image, which includes the extended portions 51 and 52, is color unevenness-reduced, thereby, a result as shown in FIG. 3(c) is obtained.

In the extended portions 51 and 52 and outer portions thereof, the background image affects to generate different color components from the uni-color. However, the extended portions 51 and 52 and the outer portions thereof are the outside of the original image.

Next, as shown in FIG. 3(d), when a line image is extracted from a FIG. 2 adjacent to the FIG. 1 and the extracted line image is processed similarly, a result as shown in FIG. 3(e) is obtained. Extended portions 61 and 62 are added to the line image of the FIG. 2.

As surrounded by a mark of “O” in FIG. 3(e), in an adjacent portion of the FIG. 1 and the FIG. 2, the extended portion 61 from the FIG. 2 overlaps with the extended portion 52 from the FIG. 1, the different color components from the uni-color are overwritten by the extended portions 52 and 61. Thereby, in the adjacent portion, components of the background image, which may cause a front of discontinuity, diminish. Consequently, the front of discontinuity, which is not expected, does not appear.

When the above processes are repeated for all lines of the FIG. 1 and all lines of the FIG. 2, as shown in FIG. 4, the front of discontinuity does not appear, and a display result that the FIG. 1 and the FIG. 2 continue smoothly, is obtained.

According to the present invention, in drawing graphics using pixel sub-component, avoiding the front of discontinuity, which is not expected, quality of display appearance is improved. In particular, when a plurality of polygons is drawn adjacently, the present invention earns high practical effects.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A display method, using a display device having a display screen, the display screen having a plurality of lines, each of the plurality of lines having a plurality of pixels in a fixed order, each of the plurality of pixels having a plurality of light emitting elements, each of the plurality of light emitting elements corresponding to one of a plurality of pixel sub-components, the display method comprising:
filtering image data using a filter having taps to output filtered image data comprising the plurality of pixel sub-components;
storing the filtered image data to a frame memory; and
controlling each of the plurality of light emitting elements according to the filtered image data comprising the plurality of pixel sub-components in the frame memory to make the display screen display the image data,
wherein, when a first figure and a second figure are drawn adjacently, figure extension in at least one of the first figure and the second figure is performed such that the first figure and the second figure have an overlap area.

2. A display method as recited in claim 1, wherein the figure extension is based on data of a figure to be extended, the figure being one of the first figure and the second figure.

3. A display method as recited in claim 1, wherein the figure extension is based on data of an adjacent figure of a figure to be extended, the figure being one of the first figure and the second figure.

4. A display method as recited in claim 1, wherein width of the overlap area is determined according to a number of the taps of the filter.

5. A display method as recited in claim 4, wherein, when the number of the taps of the filter is a value of “5”, the width of the overlap area is width of two light emitting elements.

6. A display method as recited in claim 5, wherein the figure extension is performed for both sides of the first figure and both sides of the second figure, by width of one light emitting element in a direction that the plurality of light emitting elements are aligned.

7. A display method, using a display device having a display screen, the display screen having a plurality of lines, each of the plurality of lines having a plurality of pixels in a fixed order, each of the plurality of pixels having a plurality of light emitting elements, each of the plurality of light emitting elements corresponding to one of a plurality of pixel sub-components, the display method comprising:
filtering image data using a filter having taps to output filtered image data comprising the plurality of pixel sub-components;
storing the filtered image data to a frame memory; and controlling each of the plurality of light emitting elements according to the filtered image data comprising the plurality of pixel sub-components in the frame memory to make the display screen display the image data,
wherein, when a first figure and a second figure are drawn adjacently, said filtering the image data using the filter having taps to output the filtered image data comprising the plurality of pixel sub-components, excludes a portion of an adjoining side of the first figure and the second figure from an object that the filter operates.

8. A display apparatus comprising:
a frame memory;
a display device comprising a display screen, said display screen comprising a plurality of lines, each of said plurality of lines comprising a plurality of pixels in a fixed order, each of said plurality of pixels comprising a plurality of light emitting elements, each of said plurality of light emitting elements corresponding to one of a plurality of pixel sub-components stored in said frame memory;
a driver operable to control independently each of said plurality of light emitting elements of said display device according to said plurality of pixel sub-components stored in said frame memory;
an image data-supplying unit operable to supply image data; and
a sub-pixel rendering unit operable to filter the image data supplied by said image data-supplying unit to output a filter result, and operable to store the filter result in said frame memory,
wherein, when a first figure and a second figure are drawn adjacently, said sub-pixel rendering unit performs figure extension in at least one of the first figure and the second figure such that the first figure and the second figure have an overlap area.

9. A display apparatus as recited in claim 8, wherein the figure extension is based on data of a figure to be extended, the figure being one of the first figure and the second figure.

10. A display apparatus as recited in claim 8, wherein the figure extension is based on data of an adjacent figure of a figure to be extended, the figure being one of the first figure and the second figure.

11. A display apparatus as recited in claim 8, wherein width of the overlap area is determined according to the number of the taps of the filter.

12. A display apparatus as recited in claim 11, wherein, when the number of the taps of the filter is a value of “5”, the width of the overlap area is width of two light emitting elements.

13. A display apparatus as recited in claim 12, wherein the figure extension is performed for both sides of the first figure and both sides of the second figure, by width of one light emitting element in a direction that the plurality of light emitting elements are aligned.

14. A display apparatus comprising:
a frame memory;
a display device comprising a display screen, said display screen comprising a plurality of lines, each of said plurality of lines comprising a plurality of pixels in a fixed order, each of said plurality of pixels comprising a plurality of light emitting elements, each of said plurality of light emitting elements corresponding to one of a plurality of pixel sub-components stored in said frame memory;
a driver operable to control independently each of said plurality of light emitting elements of said display device according to said plurality of pixel sub-components stored in said frame memory;
an image data-supplying unit operable to supply image data; and
a sub-pixel rendering unit operable to filter the image data supplied by said image data-supplying unit to output a filter result, and operable to store the filter result in said frame memory,
wherein said sub-pixel rendering unit comprises an adjoining side-searching unit operable to search an adjoining side of a first figure and a second figure among image data supplied by said image data-supplying unit, and
wherein said sub-pixel rendering unit excludes the adjoining side searched by said adjoining side-searching unit from an object to be filtered.
